(19) United States
(12) Patent Application Publication
(10) Pub. No.: US 2025/0200989 A1
(43) Pub. Date: Jun. 19, 2025

(54) RECOGNITION DEVICE FOR TRAFFIC SIGN

(71) Applicant: TOYOTA JIDOSHA KABUSHIKI KAISHA, Toyota-shi (JP)

(72) Inventor: Atsushi ISHII, Toyota-shi (JP)

(73) Assignee: TOYOTA JIDOSHA KABUSHIKI KAISHA, Toyota-shi (JP)

(21) Appl. No.: 18/952,238

(22) Filed: Nov. 19, 2024

(30) Foreign Application Priority Data
Dec. 18, 2023 (JP) 2023-213114

(51) Int. Cl. G06V 20/58; G06T 7/73

(52) U.S. Cl. CPC G06V 20/582; G06T 7/73; G06T 2207/30241

(57) ABSTRACT

An intersection that a vehicle is planned to enter is identified based on map information. When a traffic sign is recognized from image information acquired in the vicinity of an intersection, an inter-virtual-plane angle indicating an angle formed by a first imaginary plane orthogonal to an information display face of the traffic sign and a second virtual plane perpendicular to a first road on which the vehicle travels and including a reference line in the traveling direction of the first road is calculated. Based on information on the road intersection angle at the intersection to be entered, an inter-road angle indicating an angle formed by the second road intersecting the first road and a virtual road orthogonal to the first road is calculated. Based on the inter-virtual-plane angle and the inter-road angle, it is determined whether the recognized traffic sign corresponds to a traffic sign related to the first road.

### CROSS-REFERENCE TO RELATED APPLICATION

This application claims priority to Japanese Patent Application No. 2023-213114 filed on Dec. 18, 2023, incorporated herein by reference in its entirety.

### BACKGROUND

### 1. Technical Field

The present disclosure relates to a device for recognizing a traffic sign provided on a road.

### 2. Description of Related Art

Japanese Unexamined Patent Application Publication No. 2017-102665 (JP 2017-102665 A) discloses a device for assisting a driver in driving of a vehicle. The conventional device acquires image information from a camera of the vehicle, and determines whether a stop sign or an entry-prohibited sign recognized from the image information is applicable to the own vehicle. Stop signs and entry-prohibited signs tend to be installed on both sides of a road for the purpose of calling attention. Using this tendency, the conventional device determines that the sign that is recognized is not applicable to the own vehicle when two stop signs or entry-prohibited signs are recognized on one side of the road.

### SUMMARY

It is important to determine whether various types of traffic signs recognized from the image information of the camera are applied to the own vehicle from the perspective of supporting the user in driving of the vehicle, not limited to a part of traffic signs such as stop signs and entry-prohibited signs. In particular, in urban areas, a great many traffic signs tend to be installed in vicinities of intersections. Accordingly, there is room for improvement regarding suppressing a situation in which a traffic sign of a road intersecting a road on which the own vehicle travels is erroneously determined to be applied to the own vehicle.

An object of the present disclosure is to provide a device capable of determining whether a traffic sign recognized in the vicinity of an intersection is applicable to an own vehicle.

The present disclosure is a device for recognizing a traffic sign provided on a road, and has the following features.

The device includes a camera, a storage device, and a processor. The camera is installed in a vehicle. The camera also obtains image information forward of the vehicle. In the storage device, map information including traffic signs provided on roads is stored. The processor is configured to perform various types of information processing.

The processor
identifies, based on the map information, an intersection that the vehicle is planned to enter, calculates, when a traffic sign is recognized from the image information acquired in a vicinity of the intersection regarding which entry is planned, an inter-virtual-plane angle indicating an angle formed by a first virtual plane and a second virtual plane, in which the first virtual plane is a plane orthogonal to an information display face of the traffic sign that is recognized, and the second virtual plane is a plane perpendicular to a first road on which the vehicle is traveling and includes a reference line in a direction of travel on the first road, calculates, based on information of the road intersection angle at the intersection regarding which entry is planned, an inter-road angle indicating an angle between a second road intersecting the first road at the intersection regarding which entry is planned, and a virtual road orthogonal to the first road at the intersection regarding which entry is planned, and determines, based on the inter-virtual-plane angle that is calculated and the inter-road angle that is calculated, whether the traffic sign that is recognized corresponds to a traffic sign related to the first road.

According to the present disclosure, whether a traffic sign that is recognized corresponds to a traffic sign related to a road on which a vehicle is traveling can be determined on the basis of an inter-virtual-plane angle and an inter-road angle that are each calculated when a traffic sign is recognized from the image information acquired in the vicinity of an intersection regarding which entry is planned for the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating an example of an overall configuration of a driving assistance system including a traffic sign recognition device according to an embodiment;

FIG. 2 is a diagram for explaining the focus of the embodiment;

FIG. 3 is a diagram illustrating a method of determination performed in the embodiment; and

FIG. 4 is a flowchart illustrating an example process particularly related to an embodiment.

### DETAILED DESCRIPTION OF EMBODIMENTS

Hereinafter, embodiments of the present disclosure will be described with reference to the drawings. However, the structures and the like described in the following embodiments are not necessarily essential to the present disclosure except for the case where they are particularly explicitly described or are clearly specified in principle.

### 1. Sample System Configuration

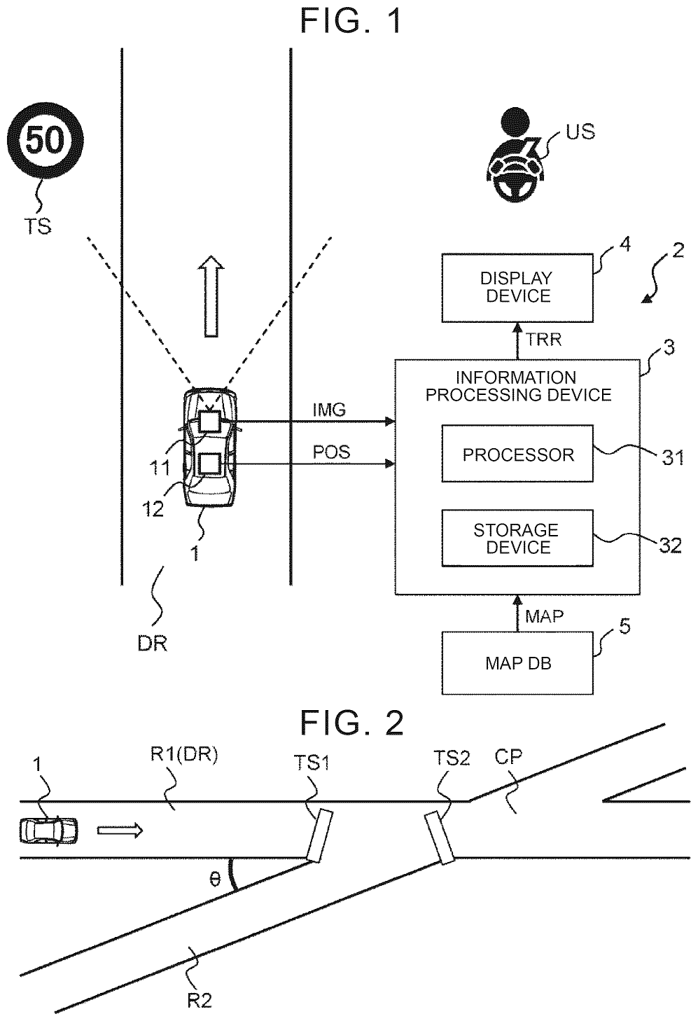

FIG. 1 is a conceptual diagram illustrating an example of an overall configuration of a driving assistance system including a traffic sign recognition device according to an embodiment. The driving assistance system 2 notifies the user US of the vehicle 1 of the information. The user US is, for example, an operator of the vehicle 1. The operator of the vehicle 1 may be a driver riding on the vehicle 1, or may be a remote operator that remotely operates (remote driving, remote support) the vehicle 1. The vehicle 1 may be a manual driving vehicle or an automatic driving vehicle. The driving assistance system 2 may be mounted on the vehicle 1 or may be included in a remote operator terminal operated by a remote operator. A part of the driving assistance system 2 may be included in the cloud server.

The driving assistance system 2 includes an information processing device 3, a display device 4, and a map database (DB) 5. The information processing device 3 includes at least one processor 31 and at least one storage device 32. The processor 31 executes various kinds of information processing. Examples of the processor 31 include a central processing unit (CPU), a graphics processing unit (GPU), application specific integrated circuits (ASICs), a field-programmable gate array (FPGA), and the like. The storage device 32 stores various types of information. Examples of the storage device 32 include volatile memory, non-volatile memory, a hard disk drive (HDD), a solid state drive (SSD), and the like.

The information processing device 3 acquires image information IMG in front of the traveling road DR of the vehicle 1 from the camera 11 mounted on the vehicle 1. The information processing device 3 also recognizes the traffic sign TS included in the image information IMG by analyzing the image information IMG. When the traffic sign TS is recognized, the information processing device 3 outputs traffic rule TRR indicated by the recognized traffic sign TS (hereinafter, also referred to as “recognition sign RTS”) to the display device 4.

The information processing device 3 acquires position information POS indicating the position (latitude and longitude) of the vehicle 1 from a global navigation satellite system (GNSS) sensor 12 mounted on the vehicle 1. The information processing device 3 also specifies the traveling road DR on the basis of the history of the position information POS and the map information MAP stored in the map DB 5. The information processing device 3 further identifies the intersection at which the vehicle 1 is scheduled to enter, based on the history of the position information POS and the map information MAP.

The display device 4 displays the traffic rule TRR received from the information processing device 3. The display device 4 may be a display or a Head-Up Display (HUD) mounted on the vehicle 1, or may be a display of a remote operator terminal. The traffic rule TRR is information about a traffic rule related to a traveling road DR. Examples of the traffic rule TRR include images of traffic sign TS, icons of traffic sign TS, or content indicated by traffic sign TS.

The map DB 5 is formed in a predetermined storage device (for example, a non-volatile recording medium such as a hard disk or a flash memory). The map DB 5 stores a map information MAP. The map information MAP includes a generic navigational map. Examples of the information included in the navigation map include information on a position of a road, information on a road shape (for example, a curve, a type of a straight line), information on an intersection, and information on a position of a structure. As information specific to the present disclosure, the map information MAP includes information on a road intersection angle θ indicating an angle formed by two roads intersecting at the intersection CP.

Examples of the components of the recognition device according to the embodiment include the above-described camera 11, GNSS sensor 12, the information processing device 3, and the map DB 5.

### 2. Features of the Embodiments

FIG. 2 is a diagram for describing the viewpoint of the embodiment. In FIG. 2, the road R1 and R2 are depicted. The road R1 and R2 intersect at the intersection CP. The road R1 is also a traveling road DR of the vehicle 1. A road R1 as a traveling road DR is an example of a “first road” of the present disclosure, and a road R2 intersecting the traveling road DR is an example of a “second road” of the present disclosure.

A traffic sign TS1 and a TS2 are installed at the intersection CP. In a typical intersection, the road intersection angle θ is designed to be at or close to 90° (e.g., 80°), but the road intersection angle θ between the road R1 and the road R2 is an acute angle (e.g., 30°). When the road intersection angle θ is a narrow angle, the traffic sign (that is, the traffic sign TS1) related to the road R1 and the traffic sign (that is, the traffic sign TS2) related to the road R2 may be recognized from the image information IMG of the same vehicle. Then, there is a possibility that the information outputted from the display device 4 as the traffic rule TRR includes erroneous information.

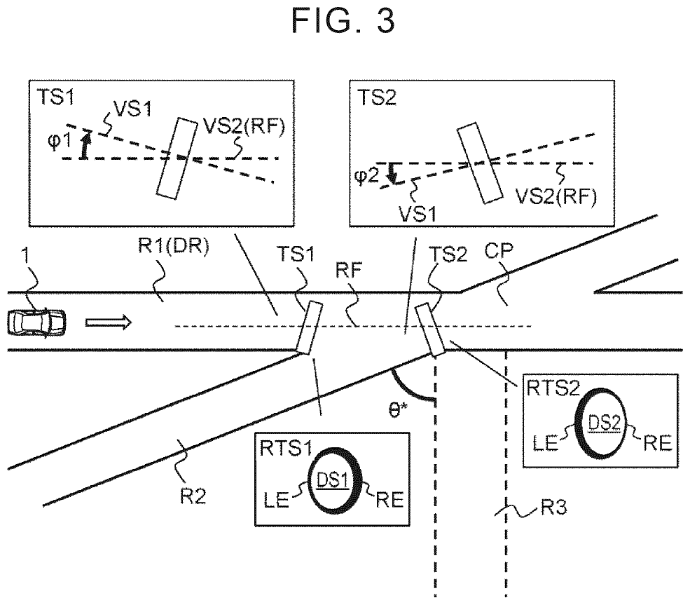

Therefore, in the embodiment, when the traffic sign TS is recognized at the intersection where the vehicle 1 is scheduled to enter, it is determined whether or not the recognition sign RTS corresponds to a traffic sign related to the traveling road RD (hereinafter, also referred to as “target sign”). FIG. 3 is a diagram for explaining an outline of a determination method of the recognition sign RTS. FIG. 3 depicts the same intersection as the intersection CP shown in FIG. 2. The intersection CP is an intersection at which the vehicle 1 is scheduled to enter.

In the determination of the recognition sign RTS, first, the inter-road angle θ* is calculated. The inter-road angle θ* indicates an angle formed by the road R2 and the virtual road R3. The virtual road R3 is set as a road perpendicular to the road R1 at the intersection CP. The road intersection angle θ formed by the road R1 and the road R2 is known from the map information MAP. Therefore, the inter-road angle θ* can be easily calculated using the road intersection angle θ (θ*=90°−θ).

In the determination of recognition sign RTS, the inter-virtual-plane angle q is also calculated. The inter-virtual-plane angle φ indicates an angle formed by the virtual plane VS1 and the virtual plane VS2. The virtual plane VS1 is an example of the “first virtual plane” of the present disclosure, and the virtual plane VS2 is an example of the “second virtual plane” of the present disclosure.

The virtual plane VS1 is calculated using an image of the traffic sign TS recognized from the image information IMG. The recognition of the traffic sign TS is performed by using an image recognition artificial intelligence (AI). The image recognition AI is generated in advance through a learning method such as deep learning. The image recognition AI is learned, for example, so that various traffic sign TS can be detected from the image information IMG and an image of the detected traffic sign TS can be extracted. When the images of the traffic sign TS are recognized, the virtual plane VS1 is calculated as a plane perpendicular to the information display face DS of the recognition sign RTS. The virtual plane VS1 is calculated by, for example, generating a depth image of the information display face DS from the traffic sign TS using the image transformation model.

The virtual plane VS2 is a plane that is perpendicular to the traveling road RD and includes a reference line RF (for example, a center line of the road R1) in a traveling direction of the traveling road RD (for example, road R1). The virtual plane VS2 is calculated using the reference line RF. The reference line RF is estimated from, for example, a demarcation line of the road R1 recognized from the image information IMG.

In the embodiment shown in FIG. 3, the traffic sign TS1 and TS2 are recognized. The inter-virtual-plane angle φ1 of the traffic sign TS1 is calculated as an angle formed by the virtual plane VS2 and the virtual plane VS1 perpendicular to the information display face DS1 of the recognition sign RTS1. The inter-virtual-plane angle φ2 of the traffic sign TS2 is calculated as an angle formed by the virtual plane VS2 and the virtual plane VS1 perpendicular to the information display face DS2 of the recognition sign RTS2.

Here, the sign of the inter-virtual-plane angle φ is negative when the left end portion LE of the information display face DS is located closer to the vehicle 1 than the right end portion RE, and positive when the right end portion RE is located closer to the vehicle 1 than the left end portion LE. In the embodiment illustrated in FIG. 3, since the left end portion LE of the information display face DS1 is located closer to the vehicle 1 than the right end portion RE, the sign of the inter-virtual-plane angle φ1 is negative. On the other hand, since the right end portion RE of the information display face DS2 is located closer to the vehicle 1 than the left end portion LE, the sign of the inter-virtual-plane angle φ2 is positive.

Once the inter-road angle θ* and the inter-virtual-plane angle φ have been calculated, the difference D (=θ*−φ) between the two is calculated. Then, when the difference D is equal to or less than a predetermined acute angle (for example, 30°), it is determined that the recognition sign RTS corresponds to the target sign. On the other hand, when the difference D is not equal to or less than the predetermined acute angle, it is determined that the recognition sign RTS does not correspond to the target sign. For example, the angle (θ*, φ1, φ2)=(60, 30, −30). Then, the value of the difference D1 (=θ*−φ1) is 30°, and the value of the difference D2 (=0*-+2) is 90°.

According to the determination method described above, it is determined that the recognition sign RTS1 corresponds to the target sign, and it is determined that the recognition sign RTS2 corresponds to the target sign. This determination is consistent with the premise of the embodiment in which the traffic sign TS1 is a traffic sign for the road R1 (i.e., the traveling road DR) and the traffic sign TS2 is a traffic sign for the road R2. Therefore, according to the embodiment in which the inter-road angle θ* and the inter-virtual-plane angle φ are calculated, it is possible to determine whether or not the recognition sign RTS corresponds to the target sign.

### 3. Example of Information Processing

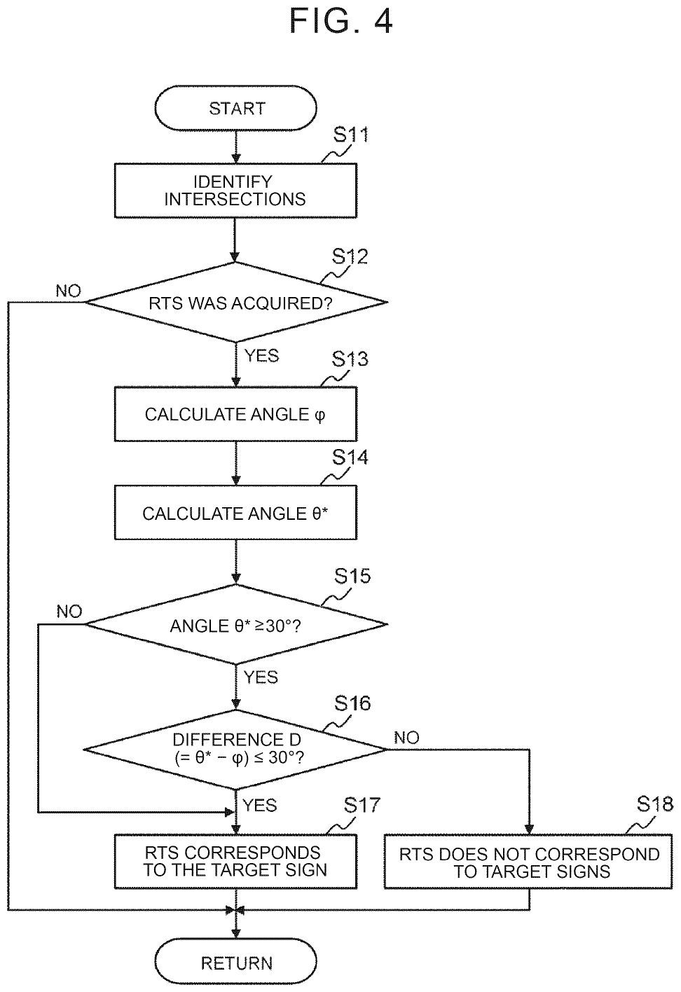

FIG. 4 is a flowchart illustrating an example process particularly related to an embodiment. The flowchart illustrated in FIG. 4 is repeatedly executed by the processor 31 illustrated in FIG. 1 at a predetermined control cycle.

In the routine illustrated in FIG. 4, first, an intersection at which the vehicle 1 is scheduled to enter is identified (S11). The intersection to be entered is identified based on the position information POS and the map information MAP. For example, the present position of the vehicle 1 and the traveling road DR are identified from the history of the position information POS. Subsequently, the intersection to be entered is identified by referring to the present position and the map information MAP using the traveling road DR.

Subsequent to S11 process, it is determined whether a recognition sign RTS has been obtained (S12). The recognition sign RTS is acquired when the traffic sign TS is recognized from the image information IMG. That is, when the traffic sign TS is not recognized, the recognition sign RTS is not acquired.

If the determination of S12 is positive, the inter-virtual-plane angle φ and the inter-road angle θ* are calculated (S13 and S14). The inter-virtual-plane angle φ is calculated as an angle formed by the virtual plane VS1 and the virtual plane VS2. The virtual plane VS1 is calculated using images of the recognition sign RTS. The virtual plane VS2 is calculated using the reference line RF. The inter-road angle θ* is calculated using the road intersection angle θ (θ*=90°−θ).

Following S14 process, it is determined whether or not the inter-road angle θ* is greater than or equal to 30° (S15). As described above, the inter-road angle θ* indicates an angle formed by the road R2 and the virtual road R3. Therefore, the fact that the inter-road angle θ* is not 30° or more means that the road intersection angle θ between the road R2 and the traveling road DR (that is, the road R1) is 60° or more. In a case where the road intersection angle θ is 60° or more, there is a high possibility that the problem described in the viewpoint of the embodiment has not occurred. Therefore, when the determination result of S15 is negative, it is determined that the recognition sign RTS corresponds to the target sign (S17).

If the determination of S15 is positive, it is determined whether or not the difference D (=θ*−φ) is equal to or less than 30° (S16). If the determination result of S16 is affirmative, it is determined that the recognition sign RTS corresponds to the target sign (S17). On the other hand, when the determination result of S16 is negative, it is determined that the recognition sign RTS does not correspond to the target sign (S18). When S17 process is performed, the recognition sign RTS is used to generate the traffic rule TRR. On the other hand, when S18 process is performed, the recognition sign RTS is rejected.

What is claimed is:

1. A device for recognizing a traffic sign provided on a road, the device comprising:
a camera that is installed in a vehicle, and that acquires image information forward of the vehicle;
a storage device in which map information, including information regarding a road intersection angle indicating an angle formed by two roads intersecting at an intersection, is stored; and
a processor that performs various types of information processing, wherein the processor is configured to execute identifying, based on the map information, an intersection that the vehicle is planned to enter,
calculating, when a traffic sign is recognized from the image information acquired in a vicinity of the intersection regarding which entry is planned, an inter-virtual-plane angle indicating an angle formed by a first virtual plane and a second virtual plane, in which the first virtual plane is a plane orthogonal to an information display face of the traffic sign that is recognized, and the second virtual plane is a plane perpendicular to a first road on which the vehicle is traveling and includes a reference line in a direction of travel on the first road,
calculating, based on information of the road intersection angle at the intersection regarding which entry is planned, an inter-road angle indicating an angle between a second road intersecting the first road at the intersection regarding which entry is planned, and a virtual road orthogonal to the first road at the intersection regarding which entry is planned, and
determining, based on the inter-virtual-plane angle that is calculated and the inter-road angle that is calculated, whether the traffic sign that is recognized corresponds to a traffic sign related to the first road.

2. The device according to claim 1, wherein the processor determines, in the determining of the traffic sign that is recognized, whether the inter-road angle that is calculated is no less than 30°, and
determines that the traffic sign that is recognized corresponds to a traffic sign related to the first road when determination is made that the inter-road angle that is calculated is not 30° or more.

3. The device according to claim 1, wherein:
a sign of the inter-virtual-plane angle is negative when a left end portion of the information display face is situated on a closer side to the vehicle than a right end portion of the information display face, and is positive when the right end portion is situated on a closer side to the vehicle than the left end portion; and
the processor determines, in the determining of the traffic sign that is recognized, whether the inter-road angle that is calculated is 30° or more,
when determination is made that the inter-road angle that is calculated is 30° or more, determines whether a difference between the inter-road angle and the inter-virtual-plane angle is 30° or less, and
when determination is made that the difference is 30° or less, determines that the traffic sign that is recognized corresponds to a traffic sign related to the first road.

4. The device according to claim 3, wherein when determination is made that the difference is not 30° or less, determines that the traffic sign that is recognized does not correspond to a traffic sign related to the first road.
